(19) United States
(12) Patent Application Publication
(10) Pub. No.: US 2026/0127556 A1
(43) Pub. Date: May 7, 2026

(54) AUTOCORRECTIVE FAILURE PREDICTIONS AND ASSISTANCE FOR COMMERCIAL BUILDINGS

(71) Applicant: Honeywell International Inc., Charlotte, NC (US)

(72) Inventors: Harsha Mathur, Bangalore (IN); Bhuvaneshwaran K, Bangalore (IN); Praveen Garikapati, Vijayawada (IN); Subha Agrawal, Karnataka (IN); Madhav Kamath, Bengaluru (IN); Manu Taranath, Bangalore (IN); Navneet Kumar, Gurgaon (IN); Prabhat Ranjan, Atlanta, GA (US)

(21) Appl. No.: 18/984,185

(22) Filed: Dec. 17, 2024

(30) Foreign Application Priority Data
Nov. 1, 2024 (IN) 202411083704

(51) Int. Cl. G06Q 10/20; G06Q 10/0639

(52) U.S. Cl. CPC G06Q 10/20; G06Q 10/06393

(57) ABSTRACT

An example method for building equipment failure prediction and autocorrection, the comprises receiving building management system data associated with building equipment at a site managed by a building management system, analyzing the building management system data or a derivative of the building management system data using a combination of: i) a physics model and ii) a machine-learning model to generate an asset health score (AHS) via the physics model; and a machine-learning score (MLS) via the anomaly detection model; determining an aggregated building equipment failure probability as a function of the AHS and the MLS; based on the aggregated building equipment probability, identifying a building equipment failure of one or more of the building equipment; determining whether the building equipment failure can be automatically remediated; and automatically remediating the building equipment failure.

### RELATED APPLICATIONS

This application claims the benefit of Indian Provisional Patent Application No. 202411083704, filed Nov. 1, 2024, which application is incorporated by reference herein.

### TECHNICAL FIELD

The present disclosure relates to systems, devices, and methods for autocorrective failure predictions and assistance for commercial buildings.

### BACKGROUND

Industrial process control and automation systems are often used to automate large and complex industrial processes. These types of systems routinely include sensors, actuators, and controllers. The controllers are often arranged hierarchically in a control and automation system. For example, lower-level controllers are often used to receive measurements from the sensors and perform process control operations to generate control signals for the actuators. Higher-level controllers are often used to perform higher-level functions, such as planning, scheduling, and optimization operations. Human process operators routinely interact with controllers and other devices in a control and automation system, such as to review warnings, alarms, or other notifications, and adjust the control or initiate performance of other operations (e.g., maintenance operations) to keep the process within desired process limits. If not properly managed, a building equipment failure such as a failure or malfunction of building equipment could escalate into an emergency, crisis, and/or disaster. Moreover, it is essential to monitor the health and functioning of various building equipment, for instance, via building management systems (BMS) systems to ensure optimal performance and achieve energy efficient goals in buildings.

Yet, at many locations, building owners may still rely on reactive maintenance (e.g., responsive to the occurrence of future building equipment failure) for fixing future building equipment failure with various building equipment (e.g., HVAC, pumps, heat exchanges, etc.). Relying solely on reactive maintenance may result in extended downtime, increased costs, and/or may negatively impact an experience of tenants and/or occupants of a building (e.g., an HVAC system experiencing a failure may lead to thermal discomfort among building occupants). Additionally, some current dashboards may provide insights into the historical performance and real-time status of the building equipment. However, to forecast when building equipment such as an elevator might require maintenance or when the HVAC system might experience a future issue (e.g., fail), manual analysis of historical data, occupancy schedules, etc. is required. This manual process is time-consuming and often inaccurate, leading to unexpected breakdowns and inefficient asset utilization.

As such, some previous approaches may attempt to predict building equipment failures (e.g., prior to an actual occurrence of an actual failure of the building equipment) and/or prior to the failures escalating into serious issues/multiples failures. For instance, some approaches may use as a series of predefined rules (e.g., based on a number of hours of operation of building equipment, etc.) that are configured to identify potential failures. However, such approaches are inflexible and may be inaccurate. Moreover, in such approaches a building equipment failure that is identified can result in a manual remediation by a technician. However, the manual remediation of building equipment failures is time-consuming, costly, and may be ineffective (e.g., the failures may remain unresolved for a longer duration of time and/or a root or contributory cause (e.g., another failure with building equipment that is upstream/downstream) of the failure may remain unresolved (e.g., be undetected and/or unremedied).

### SUMMARY

The present disclosure relates generally to systems, devices, and methods for autocorrective failure predictions and assistance for commercial buildings. The systems, devices, and methods can thereby yield enhanced analytics (e.g., contextualization), prediction, and remediation (e.g., autocorrection) of future building equipment failures such as those related to an industrial process control and automation system.

For instance, the systems, devices, and methods herein can employ a combination of a rules-based model, (e.g., to calculate an assert health score (AHS), an anomaly detection model to determine an MLS. An aggregated building equipment failure indicator can be derived from AHS and MLS, as detailed herein. The aggregated building equipment failure indicator can be used to query a plurality of supervised machine-learning models to predict probability of an occurrence of a predicted building equipment failure. In some embodiments, the AHS and the MLS (or the respective probabilities associated with the AHS and the MLS) can be unweighted. Stated differently, the AHS and the MLS (or respective probabilities based on the AHS and the MLS) can be used together as an aggregated building equipment failure indicator to query a supervised machine-learning model, as described herein, in the absence of a weight associated therewith. Such approaches can reduce an amount of programming (e.g., rules), reduce network traffic, and/or computational overhead associated with aspects herein.

However, in some embodiments the AHS, the MLS, and/or respective probabilities predicted via the rules-based model and the machine-learning models can be weighted (e.g., equally weighted or otherwise weighted) to yield a weighted aggregate probability of an occurrence of a building equipment failure (e.g., a current or future building equipment failure). In some embodiments, the weights can be adjusted (e.g., over time the weight associated with the MLS) can be attributed to a greater weight e.g., as the machine-learning models become more accurate at least due to continued retraining of the machine-learning models, etc.). For instance, responsive to completion of a recommended remediation action, various feedback (e.g., indicative of whether or not the recommended remediation action was completed and/or whether the predicted failure occurred/does not occur at a predicted time, etc.) associated with a success of the remediation action can be provided to one or more models herein such as a trained LLM, a trained supervised machine-learning model, or both. Thus, the systems, devices, and methods herein yield predict an occurrence of building equipment failures with improved accuracy, particularly over an extended period of time and yet still provide predictions that are based partially on a physics or rule-based approach.

Moreover, the systems, devices, and methods herein can readily determine a root or contributory cause (e.g., another failure with building equipment that is located upstream/downstream in a building equipment hierarchy) of a predicted building equipment failure. For example, a clustering model can be employed for feature selection and grouping failures (e.g., to initially configure a quantity, a type, or both of a plurality of trained supervised machine learning models), an anomaly detection model can be employed for identifying anomalies or deviation in trends, and ML/DL supervised model (e.g., a DNN) can be employed to predict the building equipment failure as well as explain the reason for failure (e.g., due to a failure of building equipment identified as having the building equipment failure and/or due to a failure of an upstream and/or downstream building equipment).

Additionally, the systems, devices, and methods herein permit determine if the building equipment failure can be automatically remediated (e.g., in the absence of a manual remediation by a technician or other individual) and, when possible, quickly and automatically remediate the predicted building equipment failures. Thus, the predicted building equipment failures (e.g., those with a relatively high probability of being present or occurring during a future time period) are timely remediated.

At least in view of the above, the system, devices, and methods herein, can mitigate downtime, repair/replacement costs, and/or any impact on tenants or occupants of buildings, as compared to other approaches so as those that rely solely on reactive maintenance or rely solely on predefined rules to predict/detect building equipment failures.

As used herein, a building equipment failure refers to a malfunction or breakdown of systems or devices that are integral to the operation and maintenance of a building's infrastructure such as those that are monitored by a building management system (BMS). Examples of building equipment include heating, ventilation, and air conditioning (HVAC) systems (e.g., chillers, etc.), lighting systems, security and surveillance systems, fire safety systems, plumbing and water systems, energy management systems, and transportation systems (e.g., escalators, elevators, etc.), among others. Examples of building equipment failures include an HVAC failure such as when a heating or cooling system stops functioning, resulting in uncomfortable or unsafe temperature conditions, an electrical failure such as when a power supply to lighting or security systems is interrupted, a sensor malfunction such as when a temperature, humidity, and/or occupancy sensors may fail to provide accurate data (e.g., leading to improper system responses), and/or an energy equipment failure such as a failure of a solar panels or energy storage system (e.g., leading to inefficient energy use). However, embodiments of the present disclosure are not limited to these examples. The building equipment failures may occur at a site. For instance, a site can be a single building or facility, a plurality (e.g., group) of buildings, an area (e.g., room(s), space(s), zone(s), etc.) within a building or facility, or a campus of an organization. Embodiments of the present disclosure are not limited to these examples.

A particular example of the present disclosure includes an illustrative method for building equipment failure prediction and autocorrection, the method comprising: receiving, by a computing device of a building management system, building management system data associated with building equipment at a site managed by the building management system; analyzing the building management system data or a derivative of the building management system data using a combination of: i) a physics model and ii) an anomaly detection model to generate: an asset health score (AHS) via the physics model; and a machine-learning score (MLS) via the anomaly detection model; determining an aggregated building equipment failure probability as a function of the AHS and the MLS; based on the aggregated building equipment probability, identifying a building equipment failure of one or more of the building equipment; determining whether the building equipment failure can be automatically remediated; and responsive to: determining the building equipment failure can be automatically remediated, initiating an automatic remediation of the building equipment failure; or determining the building equipment failure cannot be automatically remediated, initiating a manual remediation of the building equipment failure.

Another example of the present disclosure includes a computing device for building equipment failure prediction and autocorrection, the computing device comprising: a display; a memory; and a processor configured to receive real-world building management system data associated with building equipment at a site managed by the building management system; analyze the real-world data or a derivative of the building management system data using: a physics model to generate an asset health score (AHS); and an anomaly detection model to generate a machine-learning score (MLS); query a plurality of trained supervised machine-learning model with the AHS and the MLS to obtain an aggregated building equipment failure probability; based on the aggregated building equipment failure probability, determine an occurrence of a future building equipment failure; determine whether future building failure can be automatically remediated; and responsive to a determination that the building failure can be automatically remediated, automatically initiating a remediation action to remediate the future building equipment failure.

Another example of the present disclosure includes a non-transitory, computer-readable medium including instructions that when executed by a processor cause the processor to: a display; a memory; and a processor configured to execute executable non-transitory computer readable instructions stored in the memory to: receive real-world building management system data associated with building equipment at a site managed by the building management system; analyze the real-world building management system data or a derivative of the building management system data using: a physics model to generate an asset health score (AHS); and an anomaly detection model to generate a machine-learning score (MLS); query a plurality of trained supervised machine-learning model with the AHS and the MLS or a weighted average of the AHS and the MLS to obtain an aggregated building equipment failure probability; based on the aggregated building equipment failure probability, determine an occurrence of a future building equipment failure; determine, by querying a large language model (LLM) with at least the determined occurrence of the future building equipment failure, additional information associated with the future building equipment failure, wherein the additional information includes information indicative of whether future building equipment failure can be automatically remediated and optionally includes an indication of remediation to remedy the future building equipment failure; and responsive to a determination that the building failure can be automatically remediated, automatically initiate a remediation action to remediate the future building equipment failure.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram of an illustrative industrial process control and automation system;

FIG. 2 is an example computing device for building equipment failure prediction and autocorrection;

FIG. 3 is an example of a flow diagram showing an illustrative process for building equipment failure prediction and autocorrection;

FIG. 4 is an example of an illustrative building equipment hierarchy for building equipment failure prediction and autocorrection;

FIG. 5 is another example of an illustrative building equipment hierarchy for building equipment failure prediction and autocorrection; and

FIG. 6 is a flow diagram showing an illustrative method for building equipment failure prediction and autocorrection.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic is described in connection with an embodiment, it is contemplated that the feature, structure, or characteristic may be applied to other embodiments whether or not explicitly described unless clearly stated to the contrary.

It will be appreciated that industrial process control and automation systems require maintenance and upkeep, as well as rapid and effective responses to building equipment failures in an industrial plant (e.g., as indicated by various alarms and warnings) to maintain the industrial plant in an efficient, safe and productive environment. Various personnel such as process operators, system maintenance engineers, control engineers, field engineers, technicians may make decisions and perform maintenance and/or remediation actions to ensure the industrial process control and automation systems run under normal operating conditions. Managing and effectively deploying a large workforce of individuals and technicians is important for the efficient operation of industrial process, control, and automation systems within an industrial plant. Due to the occurrence of systematic building equipment failures and/or foreseeable building equipment failures at a site it is desired to proactively perform maintenance and/or alter operation of building equipment to mitigate a need for reactive response to actual building equipment failures (e.g., failures). That is, typical reactive maintenance (e.g., responsive to the occurrence of an actual real-time failure with various building equipment (e.g., HVAC, pumps, heat exchanges, etc.) may result in extended downtime, increased costs, and/or may negatively impact an experience of tenants and/or occupants of a building (e.g., an HVAC system experiencing a failure may lead to thermal discomfort among building occupants). Thus, the timely, effective, and, when possible, proactive remediation of future (e.g., predicted or anticipated) building equipment failures is desired.

Accordingly, the systems and methods herein can predict building equipment failures and, when permissible, can autocorrect the building equipment failures, as described herein. Thus, the systems, devices, and methods herein can yield improved functioning of various devices and individuals (e.g., operators, maintenance workers, etc.) associated with one or more sites, as detailed herein. For instance, the systems, devices, and methods herein permit the display of graphical user interfaces (in the form of live dashboards displaying various real-time information including indications of building equipment failures and corresponding recommendations to remediate the building equipment failures, as detailed herein). Building equipment operation can therefore be quantified, evaluated, and remediated in various manners which were not previously possible with legacy dashboards or other approaches. For instance, the systems, methods, and devices herein can yield real-time key metrics (e.g., a quantity, a type, and/or a status of both real-time building equipment failures over a period of time that may occur and along with the predicted building equipment failures for a future period of time). Moreover, the approaches herein yield enhanced (e.g., proactive, timely, consistent, and effective) building equipment failure resolution (e.g., autocorrection of building equipment failures), as detailed herein. The resultant benefits mentioned herein can yield safer and more effective building management and thereby can improve the efficiency and operation of various components (e.g., equipment) in the site.

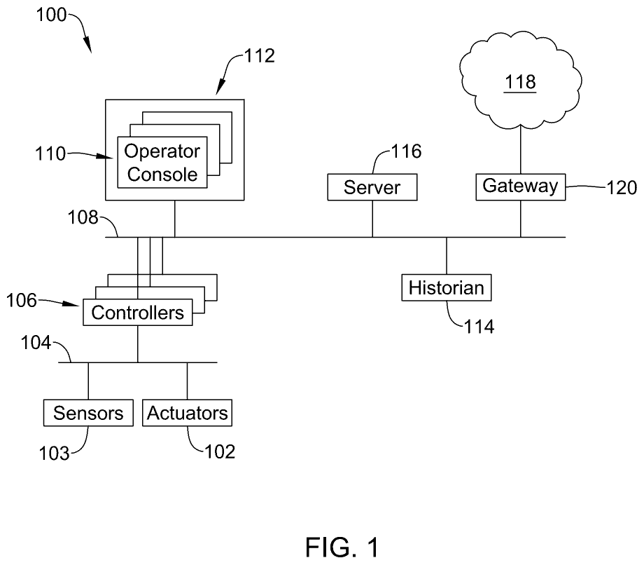

FIG. 1 provides a schematic block diagram showing an illustrative industrial process control and automation system 100. The system 100 includes various components that facilitate production or processing of at least one product or other material. For instance, the system 100 can be used to facilitate control over components in one or multiple industrial plants. The industrial plants may be one or more processing facilities (or one or more portions thereof), such as one or more manufacturing facilities for producing at least one product or other material. In general, the industrial plants may implement one or more industrial processes and can individually or collectively be referred to as a process system. A process system generally represents any system or portion thereof configured to process one or more products or other materials in some manner.

The system 100 includes one or more sensors 103 and one or more actuators 102. The sensors 103 and the actuators 102 represent components in a process system that may perform any of a wide variety of functions. In certain embodiments, sensors 103 and actuators 102 can correspond to equipment that is controlled by the automation system. That is, the sensors 103 and actuators 102 represent components in the industrial plant that perform any of a wide variety of functions. For example, sensors and actuators can measure various characteristics of the process system as well as alter any number of characteristics in the process system of the industrial plant represented by the system 100. The sensors 103 and actuators 102 can be automatically controlled by the process system of the industrial plant (e.g., to permit autocorrection of building equipment failures, as detailed herein), manually controlled, or a combination thereof. The control and manipulation of the sensors 103 by the personnel or the process system of the industrial plant, or the combination thereof can be recorded by the historian, discussed in further detail below. For example, each time the sensors 103 and actuators 102 are adjusted, a record is created within the historian. The sensors 103 may measure a wide variety of characteristics in the process system, such as but not limited to temperature, pressure, flow rate, chemical concentrations, or a voltage transmitted through an electrical conductor. The actuators 102 may represent devices that are configured to alter a wide variety of characteristics in the process system. As an example, the actuators 102 may open or close one or more valves, or increase or decrease a process set point or the like. At any rate, each sensor 103 may include any suitable structure for measuring one or more characteristics in a process system. Each actuator 102 may include any suitable structure for operating on or affecting one or more conditions of a process system.

In the example shown, a network 104 is coupled to the sensors 103 and the actuators 102. The network 104 facilitates interaction with the sensors 103 and the actuator 102. For example, the network 104 may transmit measurement data from the sensors 103 and/or may provide control signals to the actuator 102. The network 104 may represent any suitable network or combination of networks. As particular examples, the network 104 could represent at least one Ethernet network (such as one supporting a FOUNDATION FIELDBUS protocol), electrical signal network (such as a HART network), Ethernet network, pneumatic control signal network, or any other or additional type(s) of network(s), or any other type of communication path.

The illustrative system 100 also includes various controllers 106. The controllers 106 may, for example, be used in the system 100 to perform various functions in order to control one or more industrial processes. To illustrate, a first set of controllers 106 may use measurements from one or more of the sensors 103 to control the operation of one or more of the actuators 102. A controller 18 may receive measurement data from one or more sensors 103 and use the measurement data to generate control signals for one or more actuators 102. A second set of controllers 106 may be used to optimize the control logic or other operations performed by the first set of controllers. A third set of controllers 106 could be used to perform additional functions. The controllers 106 could therefore support a combination of approaches, such as regulatory control, advanced regulatory control, supervisory control, and advanced process control.

Each of the controllers 106 may include any suitable structure for controlling one or more aspects of an industrial process. At least some of the controllers 106 may, for example, represent proportional-integral-derivative (PID) controllers or multivariable controllers, such as controllers implementing model predictive control (MPC) or other advanced predictive control (APC). As a particular example, each controller of the controllers 106 may represent a computing device running a real-time operating system, a WINDOWS operating system, or other operating system.

In the illustrative system 100, at least one network 108 couples to the controllers 106 and the other devices in the system 100. The network 108 facilitates communication of information between components. The network 108 may represent any suitable network or combination of networks. For example, the network 108 could represent an Ethernet network or any other suitable communication path.

Operator access to and interaction with the controllers 106 and other components of the system 100 can occur via various operator consoles 110. Each operator console 110 may be used to provide information to an operator and receive information from an operator. For example, each operator console 110 may provide information identifying a current state of an industrial process to the operator, such as values of various process variables and warnings, alarms, or other states associated with the industrial process. Each operator console of the operator consoles 110 may also receive information affecting how the industrial process is controlled, such as by receiving set points or control modes for process variables controlled by the controllers 106 or other information that alters or affects how the controllers 106 control the industrial process. Each operator console 110 may include any suitable structure for displaying information to and interacting with an operator. For example, each operator console 110 may represent a computing device running a WINDOWS operating system or other operating system. In some embodiments, the operator console 110 can be configured to display the dashboards described herein. Alternatively or additionally, the dashboards described herein can be displayed elsewhere, for instance, at a console associated with a supervisor or other personal associated with the industrial plant.

Multiple operator consoles 110 may be grouped together and used in one or more control rooms 112. Each control room 112 may include any number of operator consoles 110 in any suitable arrangement. In some cases, multiple control rooms 112 may be used to control an industrial plant, such as when each control room 112 contains operator consoles 110 used to manage a discrete part of the industrial process/plant.

The illustrative system 100 also includes one or more servers 116. Each server 116 denotes a computing device that executes applications for users of the operator consoles 110 or other applications. The applications could be used to support various functions for the operator consoles 110, the controllers 106, or other components of the system 100. The servers 116 may be located locally or remotely from the illustrative system 100. For instance, the functionality of the server 116 could be implemented in a computing cloud or a remote server communicatively coupled to the system 100 via a gateway such as gateway 120. Each server 116 may represent a computing device running a WINDOWS operating system or other operating system. Note that while shown as being local within the system 100, the functionality of the server 116 may be remote from the system 100. For instance, the functionality of the server 116 may be implemented in a cloud-based server 118 or a remote server communicatively coupled to the system 100 via the gateway 120.

The control and automation system 100 here also includes at least one historian 114. The historian 114 represents a component that stores various information about the system 100. The historian 114 could, for instance, store information that is generated by the various controllers and/or various operators, etc. during the control of one or more industrial processes. The historian 114 includes any suitable structure for storing and facilitating retrieval of information such as a volatile and/or non-volatile memory. Although shown as a single component here, the historian 114 could be located elsewhere in the system 100, or multiple historians could be distributed in different locations in the system 100.

Although FIG. 1 shows one example of the industrial process control and automation system 100, it will be appreciated that various changes may be made. For example, the control and automation system 100 may include any number of sensors, actuators, controllers, servers, networks, operator stations, operator consoles, control rooms, networks, and other components. Also, the makeup and arrangement of the system 100 in FIG. 1 is for illustration only. Components may be added, omitted, combined, further subdivided, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates one example operational environment of an industrial plant where system operations done by the various personnel can be monitored. This functionality can be used in any other suitable system, and that system need not be used for industrial process control and automation.

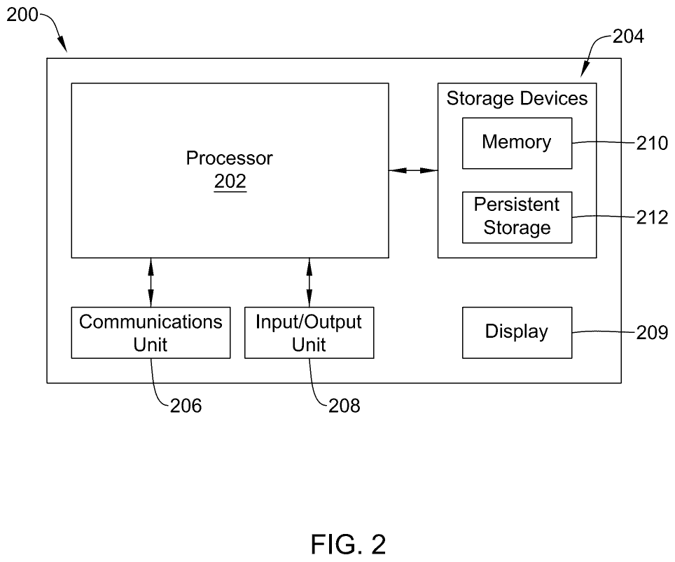

FIG. 2 illustrates an example computing device for building equipment failure prediction and autocorrection. In particular, FIG. 2 illustrates an example computing device 200. In some embodiments, the computing device 200 could denote an operator station, server, a remote server or device, or a mobile device. The computing device 200 could be used to run applications. The computing device 200 could be used to perform one or more functions, such as collecting information, sorting and analyzing the information as well as generating a report of the analysis, and/or initiating remediation (e.g., initiating an autocorrection and/or manual remediation) of an identified building equipment failure (e.g., an occurrence of a future building equipment failure for a future time period, etc.). For ease of explanation, and the computing device 200 are described as being used in the system 100 of FIG. 1, although the computing device 200 could be used in any other suitable system (whether or not related to industrial process control and automation).

As shown in FIG. 2, the computing device 200 includes at least one processor 202, at least one storage device 204, at least one communications unit 206, and at least one input/output (I/O) unit 208. Each processor 202 can execute instructions, such as those that may be loaded into a memory 210. Each processor 202 denotes any suitable processing device, such as one or more microprocessors, microcontrollers, digital signal processors, application specific integrated circuits (ASICs), field programmable gate arrays (FPGAs), or discrete circuitry.

The memory 210 and a persistent storage 212 are examples of storage devices 204, which represent any structure(s) configured to store and facilitate retrieval of information (such as data, program code, and/or other suitable information on a temporary or permanent basis). The memory 210 may represent a random-access memory or any other suitable volatile or non-volatile storage device(s). The persistent storage 212 may contain one or more components or devices supporting longer-term storage of data, such as a read-only memory, hard drive, flash memory, or optical disc.

The communications unit 206 supports communications with other systems or devices. For example, the communications unit 206 could include at least one network interface card or wireless transceiver facilitating communications over at least one wired or wireless network (such as a local intranet or a public network like the Internet). The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display such as a display 209, printer, or other suitable output device.

The display 209 allows at least output of data. In some instances, the display 209 corresponds to a monitor. In some embodiments, the display 209 corresponds to a touch screen display that allows input and output of data.

Although FIG. 2 illustrates example computing device 200 capable of facilitating or otherwise performing at least some aspects of build equipment failure prediction, tracking, analytics, and/or building equipment failure remediation may be made to FIG. 2. For example, various components in FIG. 2 could be combined, further subdivided, or omitted, and additional components could be added according to particular needs. As a particular example, processor 202 can be divided into multiple processors (e.g., hardware processors), such as one or more central processing units (CPUs) and one or more graphics processing units (GPUs). Also, computing device 200 can come in a wide variety of configurations, and FIG. 2 does not limit this disclosure to any particular computing device or mobile device.

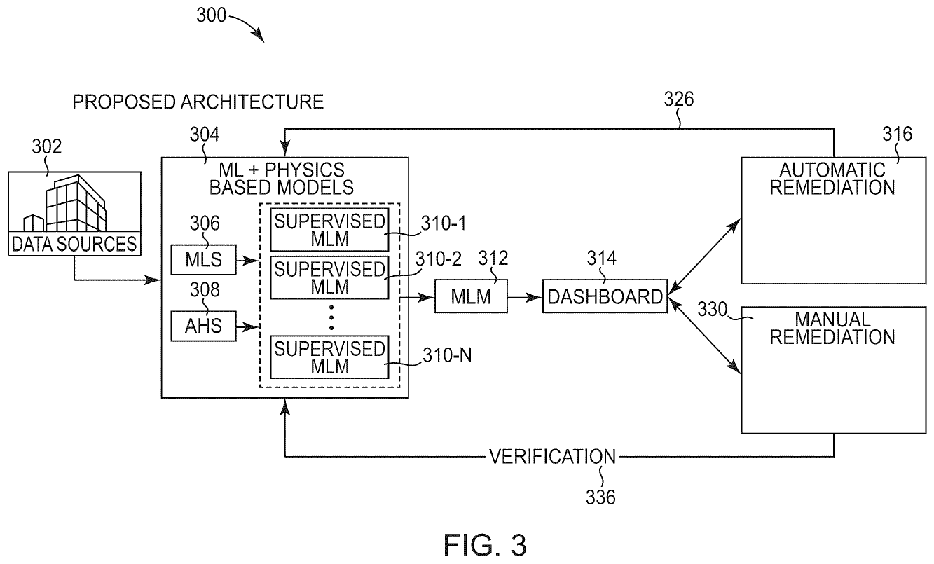

FIG. 3 is an example of a flow diagram 300 showing an illustrative process flow for building equipment failure prediction and autocorrection. At 302, the flow diagram 300 includes receiving, by a computing device (e.g., computing device 200 as described with respect to FIG. 2) of a building management system data from one or more data sources (e.g., the historian 114 of FIG. 2). The data can be received continuously, periodically (e.g., each minute, each hour, etc.), and/or can be received responsive to an input (e.g., responsive to an input by a site supervisor to a computing device such as the computing device 200, as described with respect to FIG. 2). The data can correspond to real-time or stored real world data that is indicative of actual performance and/or actual operating conditions associated with building equipment at a site. Examples of the one or more data sources include a building management system, an access control system, a video surveillance system, a weather forecasting system, a scheduling system, a maintenance log system, or any combination thereof. In some embodiments, the one or more data sources can include data from one or more internet-of-things (IOT) devices such as proximity or occupancy sensors, smart sockets, etc.

As used herein, an access control system refers to a system that monitors and regulates entry to physical spaces, combining hardware (card readers, keypads) with software for centralized control, enhanced security, and integration with other building systems. A scheduling system refers to automates and optimizes the operation of various building systems based on pre-set schedules. Scheduling systems allow building managers or facility operators to program and manage the timing of activities such as heating, ventilation, and air conditioning (HVAC), lighting, security, and other building services to enhance energy efficiency, comfort, and operational effectiveness. A maintenance log system refers to a digital tool used to manage, track, and optimize the maintenance of building equipment, ensuring efficient operations, minimizing downtime, and supporting long-term asset management. The maintenance log system can be integrated within the broader BMS platform to provide a comprehensive view of building performance and maintenance needs. The surveillance system uses cameras, video management software, and advanced analytics to monitor and secure buildings. The surveillance system can be integrated with other security and building management tools to provide centralized control, real-time monitoring, and enhanced building safety. An example of a surveillance system is PRO-WATCH™ available from HONEYWELL™, Inc. A weather forecasting system refers to a technology used to integrate weather data with building management systems. This integration allows for optimized energy usage, enhanced safety, and more efficient operations by predicting and reacting to changing weather conditions.

In some embodiments, the data can be actual performance and operating condition data received from a building management system associated with the site. For instance, the data received from the BMS can include actual performance and/or operating condition data of one or more types of building equipment (e.g., elevators, HVAC systems, sensors, etc.) that are managed by the BMS.

In some embodiments, the data can be received from a plurality of the data sources. For instance, in addition to the data (e.g., real-world data) received from the BMS, the received data can also include data (e.g., real-world data) from one or more of: an access control system, a video surveillance system, a weather forecasting system, a scheduling system, a maintenance log system, or any combination thereof. In some embodiments, the data can include information indicative of an importance or relative criticality of one of more of the building equipment, information indicative of an occupancy state of a site or portion (e.g., room) of a site, product data management (PDM) rules, and/or inputs (e.g., manual inputs provided via a computing device such as those described herein) from subject matter expert (SME) inputs. In some embodiments, the data can include intermittent (e.g., influx) and/or periodic data (e.g., end of month (EOM) data from one or more of the data sources described herein.

In some embodiments, the received data can undergo data integration (e.g., once received by a computing device such as the computing device 200 illustrated in FIG. 2). Data integration can include data aggregation, data preprocessing, and/or data cleaning of the data from one or more data sources. For instance, data received from a plurality of data sources can be aggregated to form an aggregated data set (which includes the data or a derivative of the data received from the plurality of data sources).

In some embodiments, the data received from the data sources can undergo data preprocessing or cleaning, for instance, to make the data amenable for aggregation (e.g., from two or more data sources) and/or make the data amenable for use in querying a machine-learning model, such as those described herein. The data preprocessing or cleaning can be employed to remove inaccuracies, inconsistencies, and irrelevant information from data from one or more data sources which, if present, can negatively impact predictions made based on the data.

Aggregation, preprocessing, and/or cleaning of data from one or more data sources can be performed via a rule-based process and/or a machine-learning process. For instance, in the context of a BMS or surveillance/access control systems, this could involve merging data streams from sensors, cameras, access points, and other IoT devices. As used herein, the aggregated, preprocessed, and/or cleaned data can generally be referred to as a derivative of the received data (e.g., of the received read-world data). The aggregated data set (e.g., an aggregated, preprocessed, and cleaned data set) can be stored in a centralized platform, such as ENTERPRISE BUILDINGS INTEGRATOR™ and/or FORGE; available from HONEYWELL™, Inc.

In some embodiments, the received data can include data (e.g., from a video surveillance system and/or an access control system, etc.) that is indicative of an occupancy state of one or more regions (e.g., rooms) within a site managed by the BMS. In such instances, the data from the BMS can be correlated with a given occupancy state of a region of the building (e.g., in which the building equipment is located). For instance, a given actual operating performance in time-series BMS data can be correlated with a given time occupancy state of a region in a site at various times. The given occupancy state can be determined based on the real-world data that is received. For instance, the given occupancy state of a region of a building can be determined through image analysis image of one or more images captured by a building surveillance system and/or based on a quantity of entries and exits associated with the region in a building e.g., which are determined by an access control system and indicated by access control data, etc.).

The systems, devices, and methods herein can utilize a combination of ML and Physics based Models that employ ML, deep learning (DL), physics-based models, and/or PDM (Predictive Maintenance) rules to build a comprehensive engine for identifying building equipment failures. For instance, at 304, the building management system data or a derivative of the building management system data can be analyzed by a combination of: i) a physics model and ii) a machine-learning model to generate: an asset health score (AHS) via the physics model; and a machine-learning score (MLS) via the machine-learning model.

In some embodiments, a real-time AHS for building equipment can be determined via a physics-based model, for instance, based on the data received at 302. The AHS is indicative of an actual real-time or recent health state of the building equipment as compared to a designed operating performance or initial health of the building equipment. The AHS can thus be manifested as a percentage (e.g., 60%, etc.) to readily indicate and quantify the actual health of the building equipment. In some embodiments, the AHS can be determined via the application of traditional formulas/rules to the data, received at 302, as is generally known to one of ordinary skill of the art. While the above examples refer to an AHS in the context of the physics-based model other types of metrics (e.g., KPIs) may be employed with respect to the physics-based model in addition to, or as an alternative to the AHS.

For instance, an AHS of a filter can be determined based on an actual pressure drop across a filter detected by one or more sensors (e.g., flow rate sensors, pressure sensors, etc.) associated with the filter in accordance with Equation 1, below:

$$A H S ( \% ) = \frac{DP ( ACTUAL ) - DP ( DESIGNED )}{DP ( DESIGNED ) - D P ( MIN )} * 100 ; where : \qquad ( EQ . 1 )$$

DP (ACTUAL) is an actual real world (e.g., real-time) pressure drop measured via one or more sensors.
DP (DESIGNED) is a designed or actual initial operational pressure drop across the filter; and
DP (MIN) is a minimum acceptable pressure drop value for the filter (e.g., as determined by an operator of a BMS system, etc.).

As another example, an AHS can be calculated for a heat exchanger in accordance with Equation 2, below:

$$A H S ( \% ) = \frac{U ( Observed ) - U ( MIN )}{U ( Designed - U ( MIN )} * 100 ; where : \qquad ( EQ . 2 )$$

$$U ( Calculated ) = \frac{{Q}_{coil}}{A * LMTD} ;$$

$$Rf ( Fouling factor ) = ( \frac{1}{U ( Observed )} - \frac{1}{U ( Designed )} ) ;$$

$$LMTD = \frac{DTa - DTb}{ln DTa - ln DTb} ;$$

LMTD is the log mean temperature difference between the inlet(s) and outlet(s);
U (Designed) is a manufacturer specified designed heat transfer coefficient;
A is heat transfer area of the heat exchanger; and
Qcoil is the net heat transfer as computed from a traditional coil modeling equation as is appreciated by one of ordinary skill in the art.

In some embodiments, the AHS for the building equipment can be compared to one or more threshold values, for instance, to determine whether the building equipment is experiencing or likely to experience a building equipment failure. This comparison can facilitate determination of a recommendation associated with the particular AHS. For instance, when an AHS (e.g., 30%) is less than a threshold value (e.g., 50%) a recommendation to remediate the building equipment (e.g., clean the filter, alter a setpoint, etc.) can be made. Conversely, when an AHS (e.g., 70%) is above the threshold value (e.g., 50%) a recommendation to permit the building equipment to function normally (e.g., not perform a remediation) can be made. The AHS, and in some instances a corresponding recommendation associated with the AHS can be provided to one or more supervised machine-learning models, at 310.

In some embodiments, an anomaly detection can be queried to determine a machine-learning score (MLS), as indicated at 308. In some embodiments, a trained clustering model (e.g., an unsupervised clustering model) can be trained for feature selection (e.g., trained based on subject matter expert input, etc.) and grouping building equipment failures (e.g., (e.g., to initially identify groups of potential failures/failure types) based on the received data, received at 302, and the trained anomaly detection model (e.g., an isolation forest model, etc.) can be trained to identify anomalies or deviation in trends (e.g., trends in KPIs associated with the building equipment) . . .

For purposes of this disclosure, a “clustering model” is an unsupervised machine-learning technique used to group data points into clusters based on their similarities (e.g., to permit feature selection and/or grouping of building equipment failures). Examples of suitable clustering models include: K-Means Clustering, Hierarchical Clustering, DBSCAN (Density-Based Spatial Clustering of Applications with Noise), Gaussian Mixture Models (GMM), Self-Organizing Maps (SOM), Affinity Propagation, Fuzzy C-Means Clustering, Spectral Clustering, and Mean Shift clustering models. For instance, the clustering models can analyze sensor data from equipment to cluster similar usage patterns, allowing for determination of building equipment failures. For example, the clustering model can be employed initially to determine a type, a quantity, and/or both a type and a quantity of supervised machine-learning models that are included in the systems, devices, and methods herein. That is, the clustering model can be trained e.g., based on all types of building equipment failures that are observed or are possible to determine a quantity and/or a type of machine-learning models to use for detecting building equipment failures at a particular site (e.g., based on the type, etc. of the building equipment at the particular site). In some embodiments, the clustering model can be employed for the functions described above when initially configuring a system for detection of building equipment failures at a particular site.

For purposes of this disclosure, an “anomaly detection model” is an unsupervised learning model designed to identify rare or unusual patterns in data that deviate significantly from the majority of observations. Examples of suitable anomaly detection models include isolation forests which generally refer to an ensemble-based model that isolates anomalies by partitioning the data, autoencoders which generally refer to neural networks that learn to compress and reconstruct normal data, with high reconstruction errors indicating anomalies, one-class SVM (Support Vector Machine) algorithms which generally refer to a machine-learning model that separates normal data points from potential anomalies and, LSTMs (Long Short-Term Memory networks) which are generally configured or trained to detecting anomalies in time series or sequential data. For example, the anomaly detection model can be trained on KPIs associated with building equipment for a period of time (e.g., 6 months) to establish a KPI baselines and thus the anomaly detection model can subsequently detect any deviation and extent of such deviation from the KPI baselines.

The MLS can be provided to one or more supervised MLM, at 310. The one or more supervised ML models can include at least a DNN model trained to predict a building equipment failure based at least on the combination of the AHS and the MLS. For instance, an aggregated building equipment failure probability can be determined as a function of the AHS and the MLS and the one or more supervised ML models including the DNN can be queried with the aggregated building equipment failure probability to identify one or more building equipment failures.

In some embodiments, the aggregated building equipment failure probability can be a weight aggregated building equipment failure probability with weights associated with AHS and the MLS. In some instances, the respective weights associated with the MLS and/or AHS can be determined based on a user input. For example, the user may initially set a weight associated with the AHS at a relatively high value (e.g., 50% or higher) and may subsequently elect to reduce the weight of the AHS value (e.g., to less than 50%) as the anomaly detection model becomes increasing accurate (e.g., a function of the feedback mechanisms and retraining described herein.

However, in some embodiments, the respective weights for the MLS and/or AHS can be determined automatically (in the absence of a user input). For instance, in embodiments which utilize an aggregated building equipment failure probability, the weighted aggregated building equipment failure probability can be determined in accordance with Equation 3, below:

$$Aggregated building equipment failure probability ( \% ) = [ W 1 * AHS ] + [ W 2 * MLS ] ; where : \qquad ( EQ . 3 )$$

Aggregated building equipment failure is an aggregated score indicative of a probability of an occurrence of a building equipment failure;
AHS is the asset health score for building equipment, as described herein;
MLS is a machine-learning score for the building equipment, as described herein; and
W1 and W2 are weights attributed to the AHS and MLS, respectively.

As indicated in EQ. 3, the aggregated building equipment failure probability is a function at least of a weighted average of the AHS and MLS. In some embodiments, the weights W1 and W2 can vary. For instance, in some embodiments, the weights W1 and W2 can vary or be adjusted based on a model lifecycle on the one or more machine-learning models. For example, the weighted average can at least initially be configured as an equal weight average of the physics-based model and the data-drive model (e.g., where W1 and W2 are equal values). Yet, the weight can be adjusted (e.g., automatically via a computing device such as those described herein over time). For instance, the weight (W2) associated with the machine-learning models can be attributed a greater weight (e.g., a larger value than W1) as the machine-learning models become more accurate, etc.). In such instances, the weights, W1 and W2, can be continually or periodically adjusted (e.g., responsive to one or more instances of retraining of the ML models). Such retraining and adjustment of the weights can promote aspects herein. For instance, the systems, devices, and methods herein can readily identify future building equipment failures with a high degree of statistical confidence (e.g., 95% or greater).

That is, the systems, devices and methods explained in the present disclosure involve the use of processing with a clustering model, an anomaly detection model, a plurality of supervised learning models (e.g., DNN), and a LLM to determine building equipment failures. The supervised machine-learning models herein can be trained to detect a future failure of building equipment. For instance, the supervised machine-learning models can be trained with an aggregated data set that includes real-world data or a derivative of real-world data from two or more data sources described herein. Training the supervised machine-learning models with the aggregated data set can yield trained machined-learning models that are trained to detect future failures of building equipment in a site managed by a BMS with enhanced accuracy, for instance, as compared to other approaches such as those that train machine-learning models with an individual data set from an individual data source and/or that rely on manual analysis of data (e.g., manual analysis of operating condition, manual analysis of operating performance, and/or manual analysis of maintenance records associated with building equipment, etc.). In some embodiments, the aggregated building equipment failure probability can be determined based on the building equipment hierarchy, as detailed herein. For instance, the aggregated building equipment failure probability can be determined based on the building equipment hierarchy and a weighted average of the AHS and MLS.

The output of the one or more supervised ML models can be provided to one or more large-language model (LLM), as indicated at 312. That is, the LLM can be queried with the output from the supervised ML models to determine various other information (e.g., a recommended remediation action for the building equipment failure, a historical record of the same or similar types of building equipment failures, etc.), and/or to independently validate an outcome e.g., validate the likelihood of a building equipment failure as determined based on the AHS and the MLS. For instance, the LLM can be trained to provide a diagnostic of the building equipment failure, explaining a KPIs attributing to or associated with the building equipment failure. In some embodiments the diagnostic of the building equipment failure can include providing step wise recommendations or instructions for remediation of the building equipment failure. Examples of suitable multiclass models include random forest, XGBoost, and SVM, among others. In some examples, the type and/or quantity of multiclass models utilized can be determined by or based on an output of the clustering models, described herein.

For purposes of this disclosure, a “large language model” is a computerized neural network of one million or more parameters, pre-trained on a data set of more than one million language tokens. One of ordinary skill will recognize a variety of LLM approaches and machine-learning techniques introduced in the art, including unidirectional and bidirectional frameworks, feed-forward and feedback connections, attention mechanisms, and transformers with a variety of features. Any of these tools are recognized as large language models within the art. The LLM may be customized for the purposes described herein or may be a general-purpose language model. The LLM may be cloud-based, remotely run, or locally instantiated. In some cases, the LLM may be run as part of the computer device. The LLM server 106 may in some cases include further filtration or processing associated with LLM input and/or input, such as tokenizing queries, formatting results, and/or recording exchanged data for later use and improvement. In some embodiments, the LLM can be trained based on building equipment manual, subject matter expert information and/or other information that is specific to a site including building equipment and/or a BMS system the manages the building equipment at the site.

The LLM can process the aggregated probability of the future building equipment failure to categorize the predicted building equipment failure, validate the building equipment failure (e.g., based on the AHS, MLS, and/or other information pertaining to determination of the AHS and/or MLS), and/or provide various information associated with the predicted building equipment failure. The information can include identifying information associated with the predicted building equipment failure (e.g., a location, time of occurrence, duration, building equipment identifier, etc.), an explanation of the type of building equipment failure, one or more potential remediations of the predicted building equipment failures, a historical record of the same or similar types of occurrences of building equipment failures, and/or a recommendation for remediation of the predicted building equipment failure.

The information output from the LLM can be provided to and displayed by a computing device such as those described herein, as indicated at 314. For instance, a computing device of a BMS can be configured to display a recommendation (e.g., including a remediation action and a recommended remediation deadline), a priority (e.g., low, high, etc.), and/or an indication (e.g., a quantity) of the same or similar building equipment failures.

In some embodiments, the LLM can determine at least whether the recommended remediations are automatic remediations (e.g., a closed loop remediation) or a manual remediation. For instance, the LLM can be trained to determine whether a manual (physical interaction from a technician or other individual) interaction with the building equipment (e.g., manually cleaning the building equipment) is required or whether there is an absence of a manual interaction to perform the remediation.

The flow can proceed to 316. For instance, responsive to a determination (e.g., an automatic determination by a computing device such as those described herein) that the building equipment failure can be automatically remediated the flow can proceed to 316 automatically (e.g., in the absence of an input from an operator or another individual). Similarly, in some instances responsive to a determination (e.g., an automatic determination by a computing device such as those described herein) that the building equipment failure is required to manually remediated the flow can proceed to 330 automatically (in the absence of an input from an operator or other individual).

However, in some instances, the flow can proceed to 316 responsive to an input (e.g., an input provided from an operator, etc. to a computing device such as those described herein) to proceed with a recommendation displayed via an HMI or other type of display. For instance, an input can be provided to proceed with a recommendation to perform the automatic remediation recommendation and the flow can proceed to 316, or an input can be provided to proceed with a manual remediation recommendation and the flow can proceed to 330.

At 316, automatic remediation of the building equipment failure can be performed. As used herein an automatic remediation refers to a change in the operation of building equipment that is manifested automatically (in the absence of a manual action to implement the change). The automatic remediation can be implemented by conveying a signal (e.g., from a computing device such as those described herein) to one or more sensors and/or building equipment (e.g., the building equipment in need of remediation). Examples of automatic remediation of building equipment failures include changing a setpoint, changing a valve position, regulating airflow (e.g., via changing damper positions, etc.) or changing the temperature setpoints, adjusting or turning off lighting in various areas of a site, taking building equipment (e.g., one or more elevators) off-line, shutting off a water supply to building equipment (e.g., one or more sprinkler systems), triggering a lockdown of a portion (e.g., one or more rooms) and/or an entire site, altering data (e.g., BMS data) such as smoothing a signal to attenuate noise/variance in the signal, reducing or lowering power to one or more types of building equipment, updating firmware or software associate with building equipment and/or sensor, among types of automatic (closed loop) remediations.

In various embodiments, the automatic remediation can be initiated by automatically initiating a closed-loop control action. As used herein, a closed-loop action refers to a feedback mechanism that ensures building equipment failures or improvements identified in a process are addressed systematically and efficiently. For instance, when a building equipment failure is detected, a closed-loop system can be configured to track the building equipment failure, investigate the root cause, and implement corrective measures. The “loop” can be considered closed when the failure has been resolved, and the effectiveness of the remediation has been confirmed, e.g., one or more of the feedback loops described herein (e.g., the feedback loop 326 as illustrated in FIG. 3). Hence, the closed loop remediations herein can promote aspects herein such as promoting continuous improvement with regard to detect and remediation of building equipment failures.

For instance, responsive to completion of the automatic remediation at 316, the flow can proceed to the feedback loop 326 at which point feedback associated with the automatic remediation can be provided and/or conveyed. For example, performance of the building equipment can be measured prior to, during, and/or after performing the automatic remediation to automatically infer an effectiveness of the automatic remediation and/or to yield additional data (e.g., BMS data that is automatically labeled or categorized to indicate an effectiveness of the automatic remediation) for training of one or more of the machine-learning models herein. For instance, the flow can return from the feedback loop 326 back to 304, as illustrated in FIG. 3.

At 330, a manual remediation of the building equipment failure can be performed or can be scheduled (e.g., via an electronic ticket system, etc.). As used herein, a manual remediation refers to a change in the operation of building equipment that is manifested via one or more manual actions (e.g., performed directly on the building equipment and/or a sensor or other physical component associated with the building equipment). In some embodiments, a computing device can initiate a manual remediation, for instance, via generation of an alert (e.g., which is displayed to via a computing), generation of an electronic ticket (e.g., via an electronic ticketing system such as those which are typically employed in conjunction with a BMS), or both. Examples of manual remediations include physical inspection, cleaning/maintenance (e.g., of various types of building equipment such as filters air ducts, etc.), calibration of sensors and/or building equipment, resetting building equipment and/or sensors, replacing a portion or an entire building equipment and/or sensor, replacing batteries, correcting a network (LAN or WIFI, etc. connection) setting or connection, implementing a manual override of a setting or notification, among types of manual remediations.

Responsive to completion of the manual remediation at 330, the flow can proceed to 336 at which point feedback associated with the manual remediation can be provided. For instance, performance of the building equipment can be measured prior to, during, and/or after performing the manual remediation to infer an effectiveness of the automatic remediation and/or to yield additional data (e.g., BMS data) for training of one or more of the machine-learning models herein. For example, performance of the building equipment can be measured at least prior to and after completion of the manual remediation. This building equipment performance or information indicative thereof can be displayed via a computing device such that a technician or other individual can readily ascertain a status (e.g., completed) and/or an effectiveness of the manual remediation. In some instances, the individual viewing the building equipment performance or information indicative thereof can provide an input to label or otherwise categorize the effectiveness of the remediation. In such instances, the labeled or categorized data (e.g., BMS data) can subsequently be utilized to train (e.g., retrain) one or more of the machine-learning models described herein. For instance, the flow can proceed from 336 back to 304, as illustrated in FIG. 3. Hence, the flow 300 via 326 and/or 336, as described herein, can include continuous improvement that can permit the machine-learning models to be trained (e.g., retrained). These are merely examples. Other types of retaining of one or more of the machine-learning models are possible.

In some embodiments, the systems, devices, and methods herein can predict a plurality of building equipment failure (e.g., that are predicted to occur within the same or similar time period). In such instances, the systems, devices, and methods herein can determine or receive a respective priority (e.g., low, medium, high, etc.) associated with each of the predicted building equipment and can initiate or perform (e.g., automatically remediate) remediation of the plurality of building equipment failures based on the respective priorities associated therewith. For instance, a high priority building equipment failure can undergo remediation sooner than a lower priority (e.g., medium priority) building equipment failure. For example, a plurality of building equipment failures that can be automatically remediated can undergo automatic remediation based on the priorities of the building equipment failures (e.g., a high priority building equipment failure can be automatically remediated sooner than a lower priority building equipment failure).

In some embodiments, determination of the building equipment failures and/or the respective priority of each of the building equipment failures (and hence the respective priorities of the corresponding remediation actions) can be based on: a building equipment hierarchy, a criticality of the building equipment having the predicted failure, an impact of the predicted failure on upstream and/or downstream building equipment, a quantity of hours of operation of the building equipment with the predicted failure, a degree of deviation of the building equipment from a set point of the building equipment, and a historical failure frequency of the building equipment having the predicted failure, or any combination thereof.

For instance, a building equipment hierarchy can be determined and/or received (e.g., from BMS data and/or EBI, etc.). The building equipment hierarchy can include information indicative of upstream and downstream building equipment included in the building equipment hierarchy. In some embodiments, the hierarchy can be determined based on BMS data (e.g., based on telemetry data received from one or more sensors in a BMS system) and/or can be determined based on one or more manual inputs (e.g., a manual input provided via a computing device as described herein the indicates the relative position of building equipment within a hierarchy). In some embodiments, a one or more building equipment failures can be determined based at least on the building equipment hierarchy (e.g., in addition to the weighted average of the AHA and MLS). For instance, equipment that is downstream and/or upstream relative to a building equipment may be identified as a source or root cause of another building equipment failure.

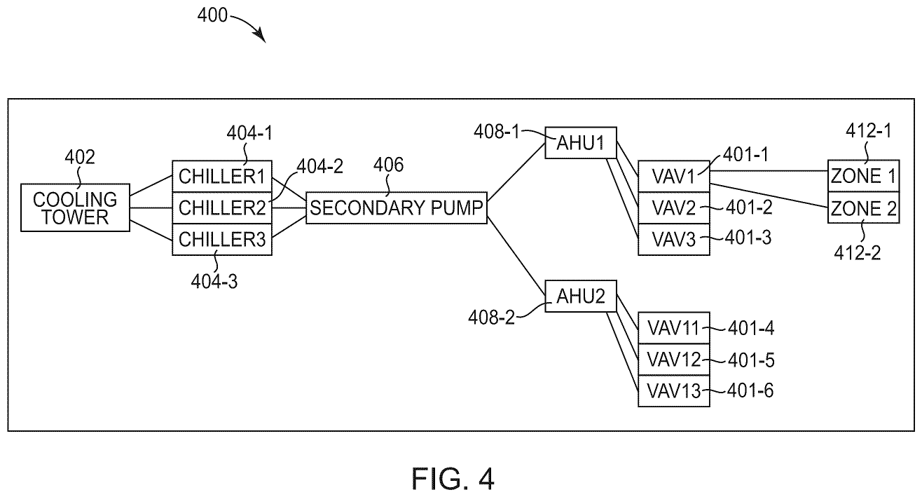

FIG. 4 is an example of an illustrative building equipment hierarchy 400 for building equipment failure prediction and autocorrection. FIG. 4 relates to building equipment included in an HVAC. The building equipment can be organized in a hierarchy. For instance, a cooling tower 402 can supply cooled fluid (e.g., water) to one or more chillers such as chillers 404-1, 404-2, and 404-3. The one or more chillers can be coupled to one more pump such as the pump 406. The chillers can supply the cooled fluid to an inlet of the pump 406. The outlet of the pump 406 can be coupled to an inlet of one or more air handling units (AHU) such as the AHUs 408-1, 408-2. An outlet of the one or more AHUs can be coupled can be coupled to one or more valves (e.g., a damper, etc.) and/or various tubing/pipes along with the valves are located. For instance, the outlet of the AHU 408-1 can be coupled to respective inlets of valves 410-1, 410-2, and 410-3 while the outlet of the AHU 408-2 can be coupled to respective inlets of the valves 410-4, 410-5, and 410-6. An outlet of one or more of the valves can be coupled to one or more heating/cooling zones (e.g., one or more rooms) 412-1, 412-2, within a site (e.g., within a building). For instance, the outlet of the valve 410-1 can be coupled to or included in a zone such as zone 412-1, as illustrated in FIG. 4.

As mentioned, in some embodiments, building equipment that is downstream and/or upstream relative to a building equipment may be identified as a source or root cause of another building equipment failure. For instance, continuing with the example in FIG. 4, a zone such as zone 412-2 may experience a failure (e.g., a temperature that exceeds a threshold temperature) that is detected by the BMS. In such instances, a root cause of the failure with the zone 412-2 can be determined. For instance, it may be determined that one or more building equipment located upstream of the zone 412-2 within the hierarchy is experiencing a building equipment failure. For instance, the valve 410-1 that is located upstream of the zone 412-2 may be in an incorrect position (e.g., closed), the AHU1 408-1 located upstream may be include a fan that is malfunctioning or operating at an incorrect setting (e.g., low speed), and/or the pump 406 may be malfunctioning or operating at an incorrect setting (e.g., low speed), etc. These are merely examples. In any case, the systems and methods herein can automatically detect occurrences of failures with building equipment located upstream and/or downstream of building equipment/a zone in a building experiencing an actual occurrence of a failure and thereby can initiate the effective and timely remediation of the root cause(s) of the failure. For instance, continuing with the above example, the systems and methods herein can automatically remediate one or more root causes (e.g., communicate a signal to automatically alter a setting (e.g., set point) of the pump 406, the AHU 408-1, and/or the valve 410-1).

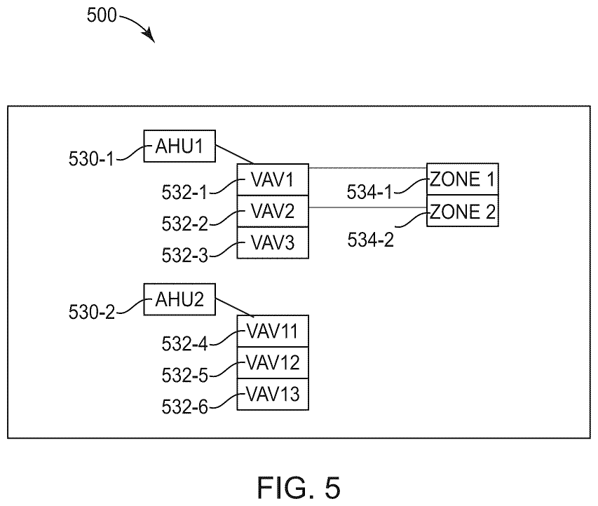

For instance, FIG. 5 is another example of an illustrative building equipment hierarchy 500 for building equipment failure prediction and autocorrection. As illustrated in FIG. 5, the outlets of one or more AHUs such as a first AHU 530-1 and a second AHU 530-2 may be coupled to an inlet of one or more valves 532-1, 532-2, 532-3, 532-4, 532-5, 532-6. The outlets of the valves may be coupled to or located in one or more zones such as a first zone 534-1 and a second zone 534-2. In the example system of FIG. 5, it may be determined that a discharge air duct static pressure of the AHU 530-1 is lower than a setpoint or threshold (e.g., based on telemetry data included in BMS data). In such instances, the system and methods herein can determine whether there is a root cause located elsewhere e.g., downstream of the AHU 530-1. For instance, the systems and methods herein may determine whether the value 532-1 is in a correct (e.g., open position), etc., e.g., based on historical data. For instance, the systems and methods herein may monitor BMS data (e.g., the AHU & VAV parameters) while the duct static pressure was meeting the setpoint and build or train a model such as those described herein. Thus, if deviation occurs, the systems and methods herein can monitor for some duration, and if need be, implement a remediation (e.g., close loop control (fan operation to be set to Auto mode) or manual remediation e.g., if the fan is already running at full speed), among other possible types of remediations.

While FIGS. 4-5 illustrates an example of building equipment failure prediction and autocorrection in the context of an HVAC system, the systems, devices, and methods herein for building equipment failure prediction and autocorrection be utilized with other types of building equipment, systems, and/or other components such as sensors. Some elements and/or interconnections in various Figures such as FIGS. 3-5 may be omitted for case of illustration.

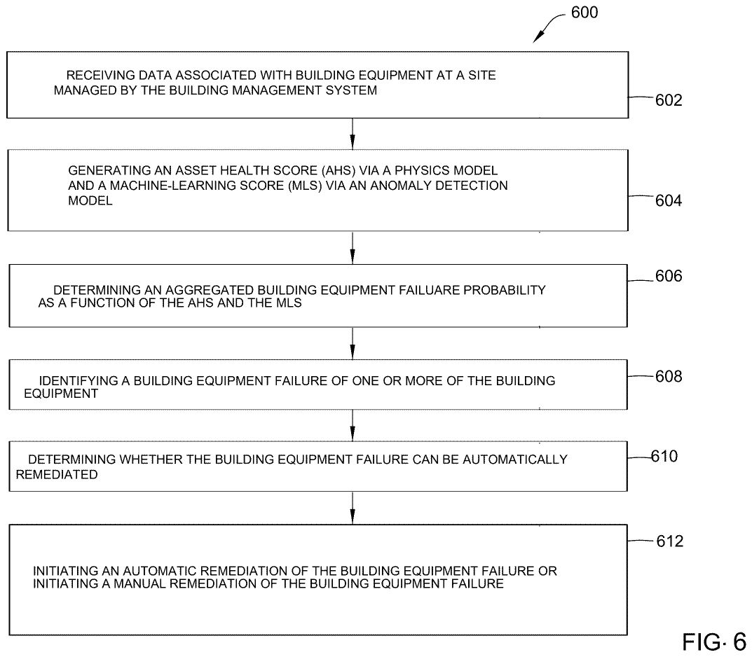

FIG. 6 is a flow diagram showing an illustrative method 600 for building equipment failure prediction and autocorrection. At 602, the method 600 includes receiving, by a computing device (e.g., computing device 200 as described with respect to FIG. 2) of a building management system, actual performance and operating condition data associated with building equipment at a site (e.g., managed by the BMS) for a time period. The actual performance and operating condition data can be received continuously, periodically (e.g., each minute, each hour, etc.), and/or can be received responsive to an input (e.g., responsive to an input by a site supervisor to a computing device such as the computing device 200, as described with respect to FIG. 2).

The method 600 can include predicting future operating performance and operating condition data for the building equipment at the site during a future time period (that has yet to occur at a time of the prediction). For instance, the method 600 can include analyzing the building management system data or a derivative of the building management system data using a combination of: i) a physics model and ii) a machine-learning model to generate: an asset health score (AHS) via the physics model; and a machine-learning score (MLS) via the machine-learning model, as indicated at 604. For example, the MLS can be predicted by querying one or more trained machine-learning models, as described herein. At 606, the method 600 can include generating an aggregated building equipment failure probability as a function of the AHS and the MLS, as described herein. At 608, the method 600 can include identifying a building equipment failure of one or more of the building equipment based on the aggregated building equipment failure probability, as described herein. For example, a probability or likelihood of an occurrence (e.g., current occurrence or future occurrence) of a building equipment failure can be identified by querying one or more trained machine-learning models (e.g., a supervised machine-learning models such as a DNN), as described herein. Stated differently, the probability or likelihood of an occurrence (e.g., current occurrence or future occurrence) of a building equipment failure can be an output from one or more trained machine-learning models, as described herein.

At 610, the method 600 can include determining whether the building equipment failure can be automatically remediated. The method 600 can further include responsive to determining the building equipment failure can be automatically remediated, initiating an automatic remediation of the building equipment failure or responsive to determining the building equipment failure cannot be automatically remediated, initiating a manual remediation of the building equipment failure, at 612.

In some embodiments, method 600 can include generating an electronic ticket to remediate a predicted future failure. In some embodiments, the method 500 includes automatically generating the electronic ticket for remediation of the predicted building equipment failure of the building equipment responsive to receipt of an indication of the presence of the predicted failure that cannot be automatically remediated. In some embodiments, the method 600 can include displaying via a computing device a recommendation for one or manual remediations (e.g., when a building equipment failure is not amenable to an automatic remediation).

In some embodiments, the method 600 includes automatically initiating a remediation action to remediate the predicted building equipment failure of the building equipment responsive to the generation of the electronic ticket, as described herein. For instance, the electronic ticket and/or a remediation action included in or associated with the electronic ticket can be assigned to one or more individuals associated with the building equipment having the predicted failure. Hence, the individual that the ticket and/or remediation action is assigned to can remediate the predicted future failure prior to a predicted time of occurrence of the future failure. Examples of remediation actions such as cleaning and/or lubricating building equipment, altering one or more set points of equipment, altering equipment (e.g., replacing one or more components of the building equipment), altering an alarm sequence, and/or altering a type and/or quantity of alarms, etc. are possible. These are merely examples and other remediation actions such as those that are typically performed in accordance with sites managed by a BMS may be performed.

In some embodiments, the systems and methods herein can be configured to generate and display, via the computing devices described herein, a report indicative of one or more of: a quantity of predicted building equipment failures; identifiers of building equipment with a predicted failure; a quantity of remediation actions, electronic tickets, or both, associated with the predicted failures; and a status of the remediation actions, electronic tickets, or both, associated with the predicted failures. Display of the report summarizing aspects associated with prediction and remediation of future failures with building equipment can promote aspects herein such as a permitting an operator or supervisor to readily quantify in real-time various information aspects associated with prediction and remediation of future failures with building equipment.

In some embodiments, the method 600 can include displaying a visual representation of a status of the remediation action. For instance, the via a graphical user interface such as those described herein. Thus, the systems, devices, and methods herein can permit identification of remediation actions based on actual (real-time information) and can provide visual representations of actual (real-time) information indicative of a status of on-going remediations, thereby providing site managers with an enhanced wholistic vantage of various aspects pertaining to building management including the proactive remediation of predicted future failures with building equipment. For instance, in some embodiments, the methods herein can display a visual representation of a total quantity and/or type of completed remediation actions, display a visual representation of a total quantity and/or type of pending (yet to be completed) remediation actions, or both. In some embodiments, the visual representations of the status of the remediation action can be specific to the site, specific to one or more operators associated with the site, or both.

Aspects of the illustrative methods herein can be performed with or via one or more of the components described herein. For instance, the illustrative methods herein can be performed in conjunction with or by at least a computing device (e.g., computing device 200), among other possible components.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in detail, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for building equipment failure prediction and autocorrection, the method comprising:
receiving, by a computing device of a building management system, building management system data associated with building equipment at a site managed by the building management system;
analyzing the building management system data or a derivative of the building management system data using a combination of: i) a physics model and ii) an anomaly detection model to generate:
an asset health score (AHS) via the physics model; and
a machine-learning score (MLS) via the anomaly detection model;
determining an aggregated building equipment failure probability as a function of the AHS and the MLS;
based on the aggregated building equipment probability, identifying a building equipment failure of one or more of the building equipment;
determining whether the building equipment failure can be automatically remediated; and
responsive to:
determining the building equipment failure can be automatically remediated, initiating an automatic remediation of the building equipment failure; or
determining the building equipment failure cannot be automatically remediated, initiating a manual remediation of the building equipment failure.

2. The method of claim 1, wherein initiating the automatic remediation comprises initiating a closed-loop control action for remediation of the building equipment with the building equipment failure.

3. The method of claim 1, wherein initiating the manual remediation comprises generating a remediation alert, generating an electronic ticket, or both.

4. The method of claim 1, wherein the anomaly detection model is a univariate or multivariate anomaly detection model that is configured to detect anomalies in key performance indicators (KPIs) associated with the building equipment.

5. The method of claim 4, further comprising querying a plurality of trained supervised machine-learning models that are trained to predict the building equipment failure based on the AHS and the MLS.

6. The method of claim 1, wherein the AHS further comprises an AHS for one or more of a heat exchanger, a chiller, a pump, a valve, a fan, a filter.

7. The method of claim 1, wherein the aggregated building equipment probability unweighted.

8. The method of claim 1, wherein the aggregated building equipment probability is a weighted aggregated building equipment probability that is a function of a weighted average of the AHS and MLS.

9. The method of claim 8, wherein the weighted average is at least initially configured as an equally weight average of the physics-based model and the data-drive model, and, wherein the weighted average is adjustable based on a model lifecycle of a plurality of trained supervised learning models that are trained to predict the building equipment failure based on the AHS and the MLS.

10. The method of claim 8, wherein the aggregated building equipment failure probability (AGBEIP) is determined in accordance with equation 1 (Eq. 1):
AGBEIP=[(W₁)*(the AHS)]+[(W₂)*(the MLS)], Eq. 1:
wherein “W₁” and “W₂” are weights attributed to the AHS and MLS, respectively.

11. The method of claim 1, further comprising:
identifying a plurality of predicted failures;
determining a plurality of remediation actions corresponding to the plurality of predicted failures;
determining a respective priority of each remediation action of the plurality of remediation actions; and
automatically initiating the plurality of remediation actions to remediate the plurality of predicted failures in accordance with the respective priorities of each of the plurality of remediation actions.

12. The method of claim 11, wherein the priority of each remediation action of the plurality of remediation actions is based on: a criticality of the building equipment having the predicted failure, an impact of the predicted failure on upstream and/or downstream building equipment, a quantity of hours of operation of the building equipment with the predicted failure, a degree of deviation of the building equipment from a set point of the building equipment, and a historical failure frequency of the building equipment having the predicted failure, or any combination thereof.

13. The method of claim 1, further comprising generating a report including information of:
a quantity of predicted failures;
a type of predicted failures;
identifiers of building equipment having a predicted failure;
locations of building equipment having a predicted failure;
a quantity of remediation actions including a quantity of completed remediation actions, a quantity of pending remediation actions, a quantity of on-going remediation actions, or any combination thereof;
a type of remediation actions including type of completed remediation actions that have been completed, a type of pending remediation actions, a type of on-going remediation actions, or any combination thereof, and
any combination thereof.

14. The method of claim 1, wherein the aggregated building equipment failure probability corresponds to an aggregated building equipment failure probability of an occurrence of a building equipment failure at future time period.

15. A computing device for building equipment failure prediction and autocorrection, the computing device comprising:
a display;
a memory; and
a processor configured to execute executable non-transitory computer readable instructions stored in the memory to:
receive real-world building management system data associated with building equipment at a site managed by the building management system;
analyze the real-world data or a derivative of the building management system data using:
a physics model to generate an asset health score (AHS); and
an anomaly detection model to generate a machine-learning score (MLS);
query a plurality of trained supervised machine-learning model with the AHS and the MLS to obtain an aggregated building equipment failure probability;
based on the aggregated building equipment failure probability, determine an occurrence of a future building equipment failure;
determine whether future building failure can be automatically remediated; and
responsive to a determination that the building failure can be automatically remediated, automatically initiating a remediation action to remediate the future building equipment failure.

16. The computing device of claim 15, wherein the supervised machine-learning model comprises a deep neural network (DNN).

17. A non-transitory, computer-readable medium including instructions that when executed by a processor cause the processor to:
receive real-world building management system data associated with building equipment at a site managed by the building management system;
analyze the real-world building management system data or a derivative of the building management system data using:
a physics model to generate an asset health score (AHS); and
an anomaly detection model to generate a machine-learning score (MLS);
query a plurality of trained supervised machine-learning model with the AHS and the MLS or a weighted average of the AHS and the MLS to obtain an aggregated building equipment failure probability;
based on the aggregated building equipment failure probability, determine an occurrence of a future building equipment failure;
determine, by querying a large language model (LLM) with at least the determined occurrence of the future building equipment failure, additional information associated with the future building equipment failure, wherein the additional information includes information indicative of whether future building equipment failure can be automatically remediated and optionally includes an indication of remediation to remedy the future building equipment failure; and
responsive to a determination that the building failure can be automatically remediated, automatically initiate a remediation action to remediate the future building equipment failure.

18. The medium of claim 17, further comprising querying a trained clustering model trained to determine a quantity, a type, or both of a quantity and a type of the plurality of supervised machine-learning models, wherein the trained clustering model is trained at least on a type of potential building equipment failures associated with the building equipment.

19. The medium of claim 18, further comprising:
determining a building equipment hierarchy including information indicative of upstream and downstream building equipment included in the building equipment hierarchy; and
determining the aggregated building equipment failure probability based on the building equipment hierarchy.

20. The medium of claim 17, further comprising:
displaying, via a display, a recommendation of a remediation action for the building equipment failure;
initiating the recommended remediation action for the building equipment failure; and
responsive to completion of the remediation action, providing feedback associated with a success of the remediation action to the plurality of trained supervised machine-learning model.
